(19) United States
(12) Patent Application Publication
(10) Pub. No.: US 2018/0129977 A1
(43) Pub. Date: May 10, 2018

(54) MACHINE LEARNING DATA ANALYSIS SYSTEM AND METHOD

(71) Applicant: Gamalon, Inc., Cambridge, MA (US)

(72) Inventors: BENJAMIN W. VIGODA, Winchester, MA (US); Matthew C. Barr, Malden, MA (US); Jacob E. Neely, Watertown, MA (US); Daniel F. Ring, San Francisco, CA (US); Martin Blood Zwirner Forsythe, Cambridge, MA (US); Ryan C. Rollings, Newton, MA (US); Thomas Markovich, Cambridge, MA (US); Pawel Jerzy Zimoch, Cambridge, MA (US); Jeffrey Finkelstein, Cambridge, MA (US); Khaldoun Makhoul, Cambridge, MA (US)

(21) Appl. No.: 15/806,874

(22) Filed: Nov. 8, 2017

Related U.S. Application Data
(60) Provisional application No. 62/419,790, filed on Nov. 9, 2016.
(60) Provisional application No. 62/453,258, filed on Feb. 1, 2017.
(60) Provisional application No. 62/516,519, filed on Jun. 7, 2017.
(60) Provisional application No. 62/520,326, filed on Jun. 15, 2017.

(51) Int. Cl. G06N 99/00; G06N 3/00; G06N 7/00

(52) U.S. Cl. CPC G06N 99/005; G06N 7/005; G06N 3/006

(57) ABSTRACT

A computer-implemented method, computer program product and computing system for defining a first feature group having a first plurality of options. At least one additional feature group having at least one additional plurality of options is defined. A first level-one sample assembly is defined that includes an option chosen from the first plurality of options and an option chosen from the at least one additional plurality of options. A level-one probabilistic model is defined based, at least in part, upon the first level-one sample assembly.

### RELATED APPLICATION(S)

This application claims the benefit of the following U.S. Provisional Application Nos. 62/419,790, filed on 9 Nov. 2016; 62/453,258, filed on 1 Feb. 2017; 62/516,519, filed on 7 Jun. 2017; and 62/520,326, filed on 15 Jun. 2017, their entire contents of which are herein incorporated by reference.

### TECHNICAL FIELD

This disclosure relates to data processing systems and, more particularly, to machine learning data processing systems.

### BACKGROUND

Businesses may receive and need to process content that comes in various formats, such as fully-structured content, semi-structured content, and unstructured content. Unfortunately, processing content that is not fully-structured (namely content that is semi-structured or unstructured) may prove to be quite difficult due to e.g., variations in formatting, variations in structure, variations in order, variations in abbreviations, etc.

Accordingly, the processing of content that is not fully-structured (e.g., semi-structured or unstructured content) may require extensive manual processing and manual reviewing in order to achieve a satisfactory result.

### SUMMARY OF DISCLOSURE

User Teachable AI Digital Assistant

In one implementation, a computer-implemented method is executed on a computing device and includes defining a first feature group having a first plurality of options. At least one additional feature group having at least one additional plurality of options is defined. A first level-one sample assembly is defined that includes an option chosen from the first plurality of options and an option chosen from the at least one additional plurality of options. A level-one probabilistic model is defined based, at least in part, upon the first level-one sample assembly.

One or more of the following features may be included. Additional level-one sample assemblies may be detected using the level-one probabilistic model. At least one additional level-one sample assembly may be defined that includes an option chosen from the first plurality of options and an option chosen from the at least one additional plurality of options. A modified level-one probabilistic model may be defined by modifying the level-one probabilistic model based, at least in part, upon the at least-one additional level-one sample assembly. Additional level-one sample assemblies may be detected using the modified level-one probabilistic model. A first level-two sample assembly may be defined that includes the first level-one sample assembly and the at least one additional level-one sample assembly. A level-two probabilistic model may be defined based, at least in part, upon the first level-two sample assembly. Additional level-two sample assemblies may be detected using the level-two probabilistic model. The first plurality of options and/or the at least one additional plurality of options may define one or more of text-based options and object-based options.

In another implementation, a computer program product resides on a computer readable medium and has a plurality of instructions stored on it. When executed by a processor, the instructions cause the processor to perform operations including defining a first feature group having a first plurality of options. At least one additional feature group having at least one additional plurality of options is defined. A first level-one sample assembly is defined that includes an option chosen from the first plurality of options and an option chosen from the at least one additional plurality of options. A level-one probabilistic model is defined based, at least in part, upon the first level-one sample assembly.

One or more of the following features may be included. Additional level-one sample assemblies may be detected using the level-one probabilistic model. At least one additional level-one sample assembly may be defined that includes an option chosen from the first plurality of options and an option chosen from the at least one additional plurality of options. A modified level-one probabilistic model may be defined by modifying the level-one probabilistic model based, at least in part, upon the at least-one additional level-one sample assembly. Additional level-one sample assemblies may be detected using the modified level-one probabilistic model. A first level-two sample assembly may be defined that includes the first level-one sample assembly and the at least one additional level-one sample assembly. A level-two probabilistic model may be defined based, at least in part, upon the first level-two sample assembly. Additional level-two sample assemblies may be detected using the level-two probabilistic model. The first plurality of options and/or the at least one additional plurality of options may define one or more of text-based options and object-based options.

In another implementation, a computing system including a processor and memory is configured to perform operations including defining a first feature group having a first plurality of options. At least one additional feature group having at least one additional plurality of options is defined. A first level-one sample assembly is defined that includes an option chosen from the first plurality of options and an option chosen from the at least one additional plurality of options. A level-one probabilistic model is defined based, at least in part, upon the first level-one sample assembly.

One or more of the following features may be included. Additional level-one sample assemblies may be detected using the level-one probabilistic model. At least one additional level-one sample assembly may be defined that includes an option chosen from the first plurality of options and an option chosen from the at least one additional plurality of options. A modified level-one probabilistic model may be defined by modifying the level-one probabilistic model based, at least in part, upon the at least-one additional level-one sample assembly. Additional level-one sample assemblies may be detected using the modified level-one probabilistic model. A first level-two sample assembly may be defined that includes the first level-one sample assembly and the at least one additional level-one sample assembly. A level-two probabilistic model may be defined based, at least in part, upon the first level-two sample assembly. Additional level-two sample assemblies may be detected using the level-two probabilistic model. The first plurality of options and/or the at least one additional plurality of options may define one or more of text-based options and object-based options.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a machine learning data analysis process according to an embodiment of the present disclosure;

FIG. 2 is a flowchart of one implementation of the machine learning data analysis process of FIG. 1 according to an embodiment of the present disclosure; and

FIG. 3 is a diagrammatic view of non-structured content for use with the machine learning data analysis process of FIG. 2;

FIG. 4 is a diagrammatic view of proposed features generated by the machine learning data analysis process of FIG. 2;

FIG. 5 is a diagrammatic view of structured content generated by the machine learning data analysis process of FIG. 2;

FIG. 6 is a diagrammatic view of various tables;

FIG. 7 is a flowchart of another implementation of the machine learning data analysis process of FIG. 1 according to an embodiment of the present disclosure;

FIG. 8 is a flowchart of another implementation of the machine learning data analysis process of FIG. 1 according to an embodiment of the present disclosure;

FIG. 9 is a diagrammatic view of object-based groups for use with the machine learning data analysis process of FIG. 8;

FIG. 10 is a flowchart of another implementation of the machine learning data analysis process of FIG. 1 according to an embodiment of the present disclosure;

FIG. 11 is a diagrammatic view of various objects; and

FIG. 12 is a flowchart of another implementation of the machine learning data analysis process of FIG. 1 according to an embodiment of the present disclosure.

Like reference symbols in the various drawings indicate like elements.

### DETAILED DESCRIPTION OF THE PREFERRED EMBODIMENTS

System Overview

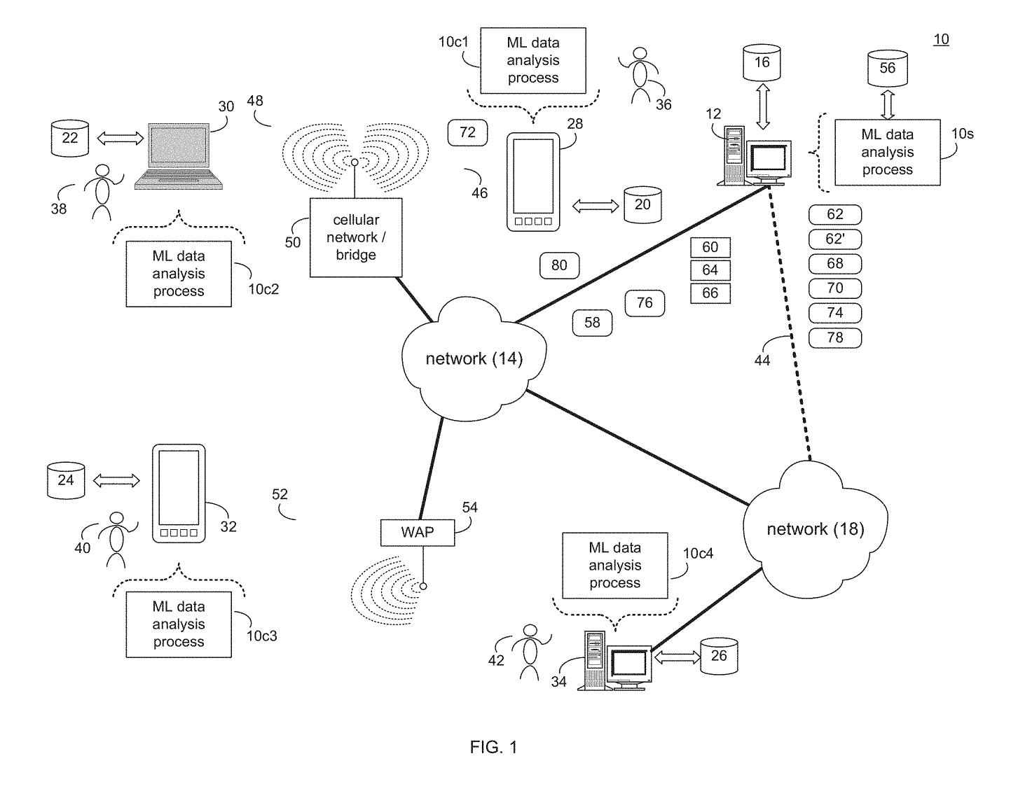

Referring to FIG. 1, there is shown machine learning data analysis process 10. Machine learning data analysis process 10 may be implemented as a server-side process, a client-side process, or a hybrid server-side/client-side process. For example, machine learning data analysis process 10 may be implemented as a purely server-side process via machine learning data analysis process 10s. Alternatively, machine learning data analysis process 10 may be implemented as a purely client-side process via one or more of client-side process 10c1, client-side process 10c2, client-side process 10c3, and client-side process 10c4. Alternatively still, machine learning data analysis process 10 may be implemented as a hybrid server-side/client-side process via data process 10s in combination with one or more of client-side process 10c1, client-side process 10c2, client-side process 10c3, and client-side process 10c4. Accordingly, machine learning data analysis process 10 as used in this disclosure may include any combination of machine learning data analysis process 10s, client-side process 10c1, client-side process 10c2, client-side process 10c3, and client-side process 10c4.

Machine learning data analysis process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of machine learning data analysis process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side processes 10c1, 10c2, 10c3, 10c4 may include but are not limited to a web browser, a game console user interface, or a specialized application (e.g., an application running on e.g., the Android™ platform or the iOS™ platform). The instruction sets and subroutines of client-side applications 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access machine learning data analysis process 10 directly through network 14 or through secondary network 18. Further, machine learning data analysis process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Machine Learning Data Analysis Process:

Assume for illustrative purposes that machine learning data analysis process 10 may be configured to process content (e.g., content 56). Examples of content 56 may include but are not limited to unstructured content; semi-structured content; and structured content.

As is known in the art, structured content may be content that is separated into independent portions (e.g., fields, columns, features) and, therefore, may have a pre-defined data model and/or is organized in a pre-defined manner. For example, if the structured content concerns an employee list: a first field, column or feature may define the first name of the employee; a second field, column or feature may define the last name of the employee; a third field, column or feature may define the home address of the employee; and a fourth field, column or feature may define the hire date of the employee.

Further and as is known in the art, unstructured content may be content that is not separated into independent portions (e.g., fields, columns, features) and, therefore, may not have a pre-defined data model and/or is not organized in a pre-defined manner. For example, if the unstructured content concerns the same employee list: the first name of the employee, the last name of the employee, the home address of the employee, and the hire date of the employee may all be combined into one field, column or feature.

Additionally and as is known in the art, semi-structured content may be content that is partially separated into independent portions (e.g., fields, columns, features) and, therefore, may partially have a pre-defined data model and/or may be partially organized in a pre-defined manner. For example, if the semi-structured data concerns the same employee list: the first name of the employee and the last name of the employee may be combined into one field, column or feature, while a second field, column or feature may define the home address of the employee; and a third field, column or feature may define the hire date of the employee.

In addition to being structured, unstructured or semi-structured, content 56 may be “noisy”, wherein “noisy” content may be substantially more difficult to process. As is known in the art, noisy content may be content that lacks the consistency to be properly and/or easily processed.

For example, unstructured content (and to a lesser extent semi-structured content) may be considered inherently noisy, since the full (or partial) lack of structure may render the unstructured (or semi-structured) content more difficult to process.

Further, structured content may be considered noisy if it lacks the requisite consistency to be easily processed. For example, if the above-described employee list is structured content that includes one field, column or feature to define the employee name, wherein the employee name is in a first name/last name format for some employees and in a last name/first name format for other employees, that content may be considered noisy even though it is structured. Further, if that same “structured” employee list defines the hire date for some employees in a mm/dd/yyyy format and for other employees in a dd/mm/yyyy format, that content may be considered noisy even though it is structured.

Accordingly, the processing of noisy unstructured content may be the most difficult content to process by machine learning data analysis process 10; while the processing of non-noisy, structured content may be the least difficult to process by machine learning data analysis process 10.

User-Teachable, AI Enhanced Data Structuring System

As discussed above, machine learning data analysis process 10 may be configured to process content (e.g., content 56), wherein examples of content 56 may include but are not limited to unstructured content, semi-structured content and structured content (that may be noisy or non-noisy).

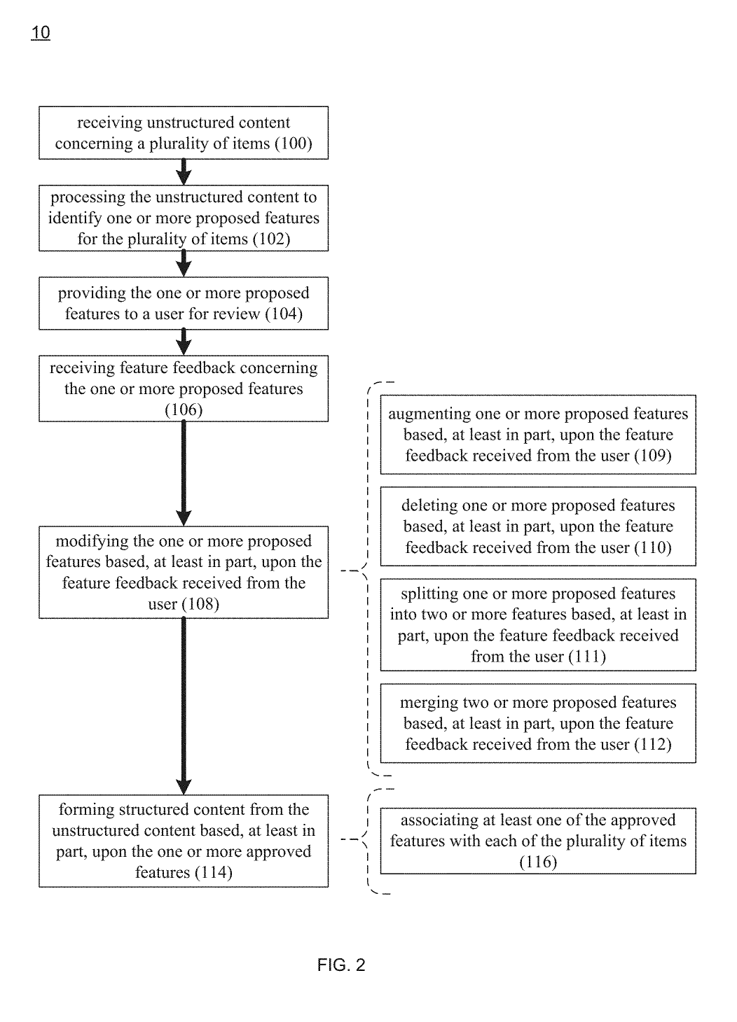

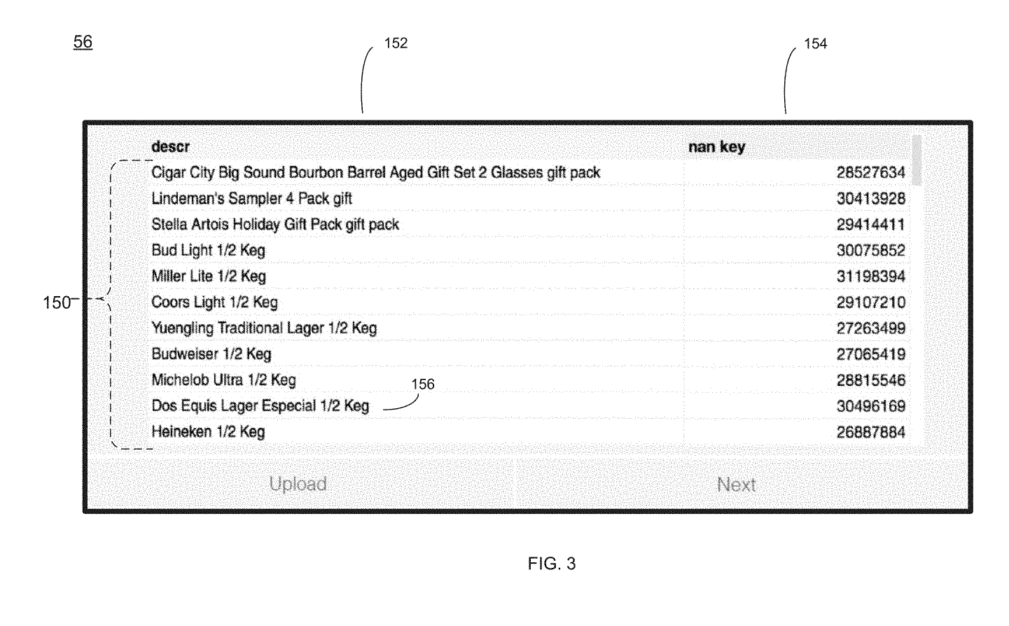

Referring also to FIGS. 2-3, assume for illustrative purposes that machine learning data analysis process 10 receives 100 content 56 for processing, wherein content 56 is non-structured content that concerns a plurality of items (e.g., plurality of items 150). Further assume (and as will be discussed below) content 56 is noisy content. As content 56 is non-structured content, content 56 may include unstructured content (as described above) and/or semi-structured content (as described above).

In this particular example, content 56 is shown to be non-structured, noisy content. For this example, content 56 is shown to concern alcoholic beverages, wherein content 56 is shown to include two different columns, namely column 152 that defines many of the features of each of plurality of items 150 and column 154 that defines a product number for each of plurality of items 150. Accordingly and for this example, content 56 may be classified as semi-structured content, since content 56 includes some structure (as the features of plurality of items 150 are divided into two columns) but it is not fully structured (as column 152 includes several features of each of plurality of items 150). For example, entry 156 within column 152 is shown to define three features, namely a brand “Dos Equis”, a product “Lager Especial” and a volume “½ Keg”.

Further, assume for this example that plurality of items 150 is for illustrative purposes only and is not intended to be all inclusive. Accordingly, plurality of items 150 may include hundreds of additional rows of items (many of which are not shown) and may include many additional feature columns (many of which are not shown). Accordingly and for this example, FIG. 3 is intended to illustrate a small portion of non-structured content (e.g., content 56).

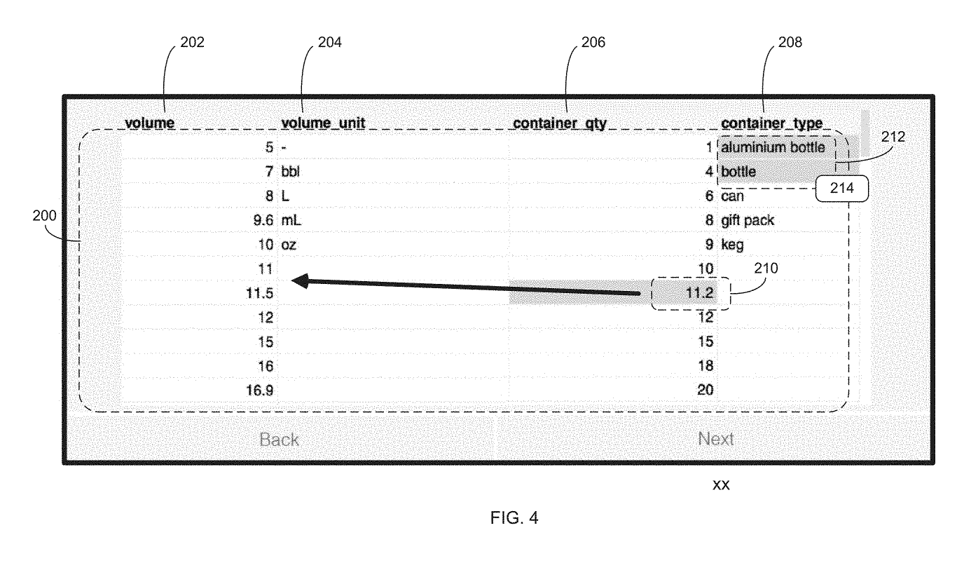

Referring also to FIG. 4, machine learning data analysis process 10 may process 102 the non-structured content (e.g., content 56) to identify one or more proposed features (e.g., proposed features 200) for plurality of items 150, wherein machine learning data analysis process 10 may provide 104 the one or more proposed features (e.g., proposed features 200) to a user (e.g., one or more of users 36, 38, 40, 42) for review. These proposed features (e.g., proposed features 200) may be grouped into two or more proposed feature categories. For this example, proposed features 200 are shown to be grouped into four proposed feature categories, namely “volume” category 202, “volume unit” category 204, “container qty” 206 and “container type” category 208.

While the one or more proposed features (e.g., proposed features 200) are shown in FIG. 4 to be text-based features, this is for illustrative purposes only and is not intended to be a limitation of this disclosure, as other configurations are possible. For example, the one or more proposed features (e.g., proposed features 200) may include but are not limited to e.g., visual features (e.g., images or objects), audio-based features (e.g., sounds or audio clips) and video-based features (e.g., animations or video clips). Additionally and for the following discussion, the term feature(s) is intended to include a single feature and a plurality of features. For example, individual features may include a “street number”, a “street name”, a “city”, a “state” and a “zip code”. Further, another feature may be an “address” feature, wherein this “address” feature may be essentially a feature category that includes a plurality of individual features (e.g., “street number”, “street name”, “city”, “state” and “zip code”), which all combined may form an address. Accordingly and for the following discussion that concerns the manner in which these features may be processed and manipulated, it is understood that these features may include individual features or may include feature “categories” that include multiple features.

Again, assume for this example that proposed feature categories 202, 204, 206, 208 are for illustrative purposes only and are not intended to be all inclusive. Accordingly, many additional columns of proposed feature categories and/or many additional rows of proposed features may be included. Accordingly and for this example, FIG. 4 is intended to illustrate a small portion of the proposed features (e.g., proposed features 200).

When processing 102 content 56 to identify proposed features 200 for plurality of items 150, machine learning data analysis process 10 may use probabilistic modeling to accomplish such processing 200, wherein examples of such probabilistic modeling may include but are not limited to discriminative modeling (e.g., a probabilistic model for only the content of interest), generative modeling (e.g., a full probabilistic model of all content), or combinations thereof.

As is known in the art, probabilistic modeling may be used within modern artificial intelligence systems (e.g., machine learning data analysis process 10), in that these probabilistic models may provide artificial intelligence systems with the tools required to autonomously analyze vast quantities of data.

Examples of the tasks for which probabilistic modeling may be utilized may include but are not limited to:
predicting media (music, movies, books) that a user may like or enjoy based upon media that the user has liked or enjoyed in the past;
transcribing words spoken by a user into editable text;
grouping genes into gene clusters;
identifying recurring patterns within vast data sets;
filtering email that is believed to be spam from a user's inbox;
generating clean (i.e., non-noisy) data from a noisy data set; and
diagnosing various medical conditions and diseases.

For each of the above-described applications of probabilistic modeling, an initial probabilistic model may be defined, wherein this initial probabilistic model may be iteratively modified and revised based upon feedback provided by users, thus allowing the probabilistic models and the artificial intelligence systems (e.g., machine learning data analysis process 10) to “learn” so that future probabilistic models may be more precise and may define more accurate data sets.

Accordingly, machine learning data analysis process 10 may use various machine learning processes and algorithms to process 102 content 56. For example, machine learning data analysis process 10 may be configured to extract individual features from e.g., columns that contain a plurality of features (e.g., column 152) and automatically generate titles for proposed feature categories 202, 204, 206, 208 (e.g., by looking for statistically salient N grams in the features within the proposed feature categories). For example and with respect to “container type” category 208, machine learning data analysis process 10 may analyze the features identified within proposed feature category 208 (e.g., “aluminum bottle”, “bottle”, “can”, “gift pack”, and “keg”), determine that these features are all “types” of “containers”, and select “container type” as a title for proposed feature category 208.

When machine learning data analysis process 10 provides 104 proposed features 100 to one or more of users 36, 38, 40, 42 for review, machine learning data analysis process 10 may be configured to identify (to the users) one or more areas within proposed features 200 that may require attention. As discussed above, machine learning data analysis process 10 may provide 104 proposed features 200 that are based upon one or more probabilistic models, wherein each of these proposed features 200 may be assigned a score by the above-described probabilistic models and/or machine learning data analysis process 10. In the event that the score assigned by these probabilistic models is below a certain threshold, machine learning data analysis process 10 may identify (to the users) these areas within proposed features 200 that require attention.

For example, machine learning data analysis process 10 may identify item 210 as a possible miscategorization (since e.g., quantities are whole numbers as opposed to fractional numbers). Accordingly, one or more of users 36, 38, 40, 42 may scrutinize this identification and, if accurate, may act upon the same. For example and upon review, one or more of users 36, 38, 40, 42 may determine that item 210 is indeed miscategorized and should actually be in “volume” category 202. Accordingly, one or more of users 36, 38, 40, 42 may “relocate” item 210 from “container qty” category 206 to “volume” category 202 via e.g., a finger swipe (if the device being used by one or more of users 36, 38, 40, 42 is a touch sensitive device) or a mouse swipe (if the device being used by one or more of users 36, 38, 40, 42 is controllable via a mouse).

Further, machine learning data analysis process 10 may identify item 212 as containing possible duplicates (e.g., “aluminum bottle” versus “bottle”). Accordingly, one or more of users 36, 38, 40, 42 may scrutinize this identification and, if accurate, may act upon the same. For example, one or more of users 36, 38, 40, 42 may determine that item 212 does not contain any duplicates and may ignore the identification. Accordingly, one or more of users 36, 38, 40, 42 may e.g., select ignore button 214 via e.g., a finger tap (if the device being used by one or more of users 36, 38, 40, 42 is a touch sensitive device) or a mouse click (if the device being used by one or more of users 36, 38, 40, 42 is controllable via a mouse).

Both of the above-described actions taken by one or more of users 36, 38, 40, 42 (e.g., taking action concerning item 210 but declining to take action concerning item 212) may be provided to machine learning data analysis process 10 in the form of feature feedback 58.

Machine learning data analysis process 10 may receive 106 feature feedback 58 concerning the one or more proposed features (e.g., proposed features 200) and may modify 108 the one or more proposed features (e.g., proposed features 200) based, at least in part, upon feature feedback 58 received from the user (e.g., one or more of users 36, 38, 40, 42), thus generating one or more approved features, wherein these approved features are features that have been modified and/or approved by the user(s).

For example, machine learning data analysis process 10 may generate a new probabilistic model (or modify an existing probabilistic model) based, at least in part, upon feature feedback 58. Accordingly, the data point that item 210 should have been placed into “volume” category 202 instead of “container qty” category 206 may be used by machine learning data analysis process 10 to modify the probabilistic model that initially placed item 210 into “container qty” category 206 so that this probabilistic model would now place item 210 into “volume” category 202.

Once machine learning data analysis process 10 generates a new probabilistic model (or modifies an existing probabilistic model) so that item 210 would now be placed into “volume” category 202, this modified probabilistic model may be used by machine learning data analysis process 10 to reprocess other items within “container qty” category 206. For example, if there were other fractional quantities (e.g., 6.6, 13.2, 33.3) defined within “container qty” category 206, machine learning data analysis process 10 may “learn” from feature feedback 58 and may automatically move any fractional quantities within “container qty” category 206 to “volume” category 202.

Accordingly, feedback (e.g., feature feedback 48) received for a specific item (e.g., item 210) within a specific group of features (e.g., proposed features 100) may be applied to other items within the same group of features or may be applied to other, subsequently-generated groups of features.

As discussed above, machine learning data analysis process 10 may receive 106 feature feedback 58 concerning (in this example) proposed features 200 and may modify 108 proposed features 200 based, at least in part, upon feature feedback 58 received from the users to generate one or more approved features.

When modifying 108 the one or more proposed features, machine learning data analysis process 10 may: augment 109 one or more proposed features based, at least in part, upon feature feedback 58 received from the user; delete 110 one or more proposed features based, at least in part, upon feature feedback 58 received from the user; split 111 one or more proposed features into two or more features based, at least in part, upon feature feedback 58 received from the user; or merge 112 two or more proposed features based, at least in part, upon feature feedback 58 received from the user.

For example, feature feedback 58 received 106 by data analysis process 10 from the user(s) may concern augmenting 109 one or more proposed features (e.g., proposed features 200). Therefore, if “container type” category 208 within proposed features 200 included the item “alum bottle”, the user(s) may choose to augment 109 this “alum bottle” item into “aluminum bottle”. Therefore, feature feedback 58 received 106 by data analysis process 10 may define this “alum bottle” item for augmentation. Accordingly and when modifying 108 proposed features 200, machine learning data analysis process 10 may augment 109 this “alum bottle” item.

Further, feature feedback 58 received 106 by data analysis process 10 from the user(s) may concern deleting 110 one or more proposed features (e.g., proposed features 200). Therefore, if “container type” category 208 within proposed features 200 included the item “green”, the user(s) may choose to delete 110 this “green” item. Therefore, feature feedback 58 received 106 by data analysis process 10 may define this “green” item for deletion. Accordingly and when modifying 108 proposed features 200, machine learning data analysis process 10 may delete 110 this “green” item.

Additionally, feature feedback 58 received 106 by data analysis process 10 from the user(s) may concern splitting 111 one or more proposed features (e.g., proposed features 200). Therefore, if “volume” category 202 within proposed features 200 included the item “10 oz.”, the user(s) may choose to split 111 this “10 oz.” item into two items (e.g., “10” for inclusion within “volume” category 202 and “oz.” within “volume unit” category 204). Therefore, feature feedback 58 received 106 by data analysis process 10 may define this “10 oz.” item for splitting. Accordingly and when modifying 108 proposed features 200, machine learning data analysis process 10 may split 111 this “10 oz.” item.

Further, feature feedback 58 received 106 by data analysis process 10 from the user(s) may concern merging 112 one or more proposed features (e.g., proposed features 200). Therefore, if “container type” category 208 within proposed features 200 included the items “keg” and “Keg”, the user(s) may choose to merge 112 these “keg” and “Keg” items. Therefore, feature feedback 58 received 106 by data analysis process 10 may define these “keg” and “Keg” items for merging. Accordingly and when modifying 108 proposed features 200, machine learning data analysis process 10 may merge 112 these “keg” and “Keg” items.

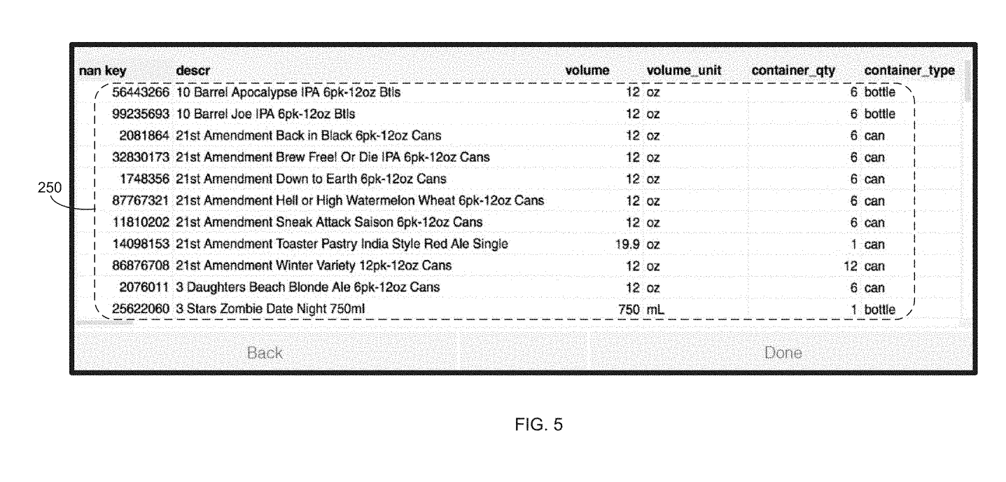

Referring also to FIG. 5, machine learning data analysis process 10 may form 114 structured content 250 from the non-structured content 56 based, at least in part, upon the one or more approved features. As discussed above, these approved features may be features that have been modified and/or approved by the user(s) and, therefore, reflect feature feedback 58. When forming 114 structured content 250 from non-structured content 56, machine learning data analysis process 10 may associate 116 at least one of the approved features with each of the plurality of items.

As discussed above, machine learning data analysis process 10 may process 102 content 56 to identify proposed features 200 for plurality of items 150 and may provide 104 these proposed features (e.g., proposed features 200) to the user(s) for review; wherein machine learning data analysis process 10 may receive 106 feature feedback 58 concerning proposed features 200 and may modify 108 proposed features 200 based, at least in part, upon feature feedback 58.

Once proposed features are modified and/or approved (to form approved features), machine learning data analysis process 10 may form 114 structured content 250 from the non-structured content 56 based upon (and utilizing) these approved features. So (in other words) the approved features are the building blocks from which machine learning data analysis process 10 may form 114 structured content 250. For example, each of the rows in structured content 250 is a specific product description representing a specific product, wherein each specific product description is assembled from (in this example) a plurality of the approved features (which may define e.g., an item number, a product name, a volume number, a volume unit, a container quantity, and a container type).

Further expanding upon the above discussion and in some configurations/embodiments, examples of content 56 may include but are not limited to natural language content and object content (e.g., drawings, images, video), wherein content 56 may be processed to identify the above-described proposed features for the plurality of items.

Examples of natural language features may include but are not limited to lists of words, wherein these lists of words may include words with word co-occurrence statistics that resemble one another. These lists of words may include words with word embedding vectors close to one another. Feature categories for natural language may include lists of lists of words, or groups of lists of words. Feature categories for natural language may be recursively defined so that there can be lists of lists of lists or groups of groups of features, etc.

Examples of drawing features may include but are not limited to lines or collections of lines that are spatially related to one another. The spatial relations may be probabilistic where e.g., the x, y position of one end of one line may be drawn from a two-dimensional Gaussian distribution with a mean at some x, y coordinates, and one end of another line may also be drawn from a two-dimensional Gaussian distribution with a mean at some x, y coordinates with some offset in relation to the mean of the first Gaussian distribution. Feature categories for drawings may include groups of features. Feature categories for drawings may be recursively defined so that there may be groups of groups of features, etc.

Examples of image features may include but are not limited to a collection of pixels that are spatially related to one another. The spatial relations may be probabilistic where e.g., the x, y position of one pixel may be drawn from a two-dimensional Gaussian distribution with a mean at some x, y coordinates, and the x, y coordinates of another pixel may be drawn from another two-dimensional Gaussian distribution with a mean at other x, y coordinates with some offset in relation to the mean of the first Gaussian distribution.

Without loss of generality: a feature may be a rectangular patch of N by M pixels, wherein N is the length of the rectangle and M is the width of the rectangle; a rectangular patch of pixels may have one or more variables defining one or more angles of rotation; and/or a rectangular patch of pixels may have one or more variables defining one or more stretch or skew.

Feature categories for images may include groups of features. Features for images may include representing a patch of P pixels as a P-dimensional vector of pixel properties (e.g., intensity, color, hue, etc.). Feature categories for images may be recursively defined so that there can be groups of groups of features, etc.

Examples of video features may include but are not limited to a collection of pixels that are spatially and temporally related to one another. The spatial relations may be somewhat probabilistic where e.g., the x, y, t (time) position of one pixel or set of pixels may be drawn from a probabilistic program, and the x, y, t coordinates of another pixel or set of pixels may be drawn from another probabilistic program. Without loss of generality, a feature may be a rectangular patch of N by M pixels where N is length of the rectangle and M is the width of the rectangle. Without loss of generality: a rectangular patch of pixels may have one or more variables defining one or more angles of rotation; and/or a rectangular patch of pixels may have one or more variables defining one or more stretch or skew.

Feature categories for video may include groups of features. Features for videos may include representing a patch of P pixels as a P-dimensional vector of pixel properties such as intensity, color, hue, etc. Feature categories for videos may be recursively defined so that there can be groups of groups of features, etc.

User-Teachable Metadata-Free ETL System

As discussed above, machine learning data analysis process 10 may be configured to process content (e.g., content 56), wherein examples of content 56 may include but are not limited to unstructured content, semi-structured content and structured content (that may be noisy or non-noisy).

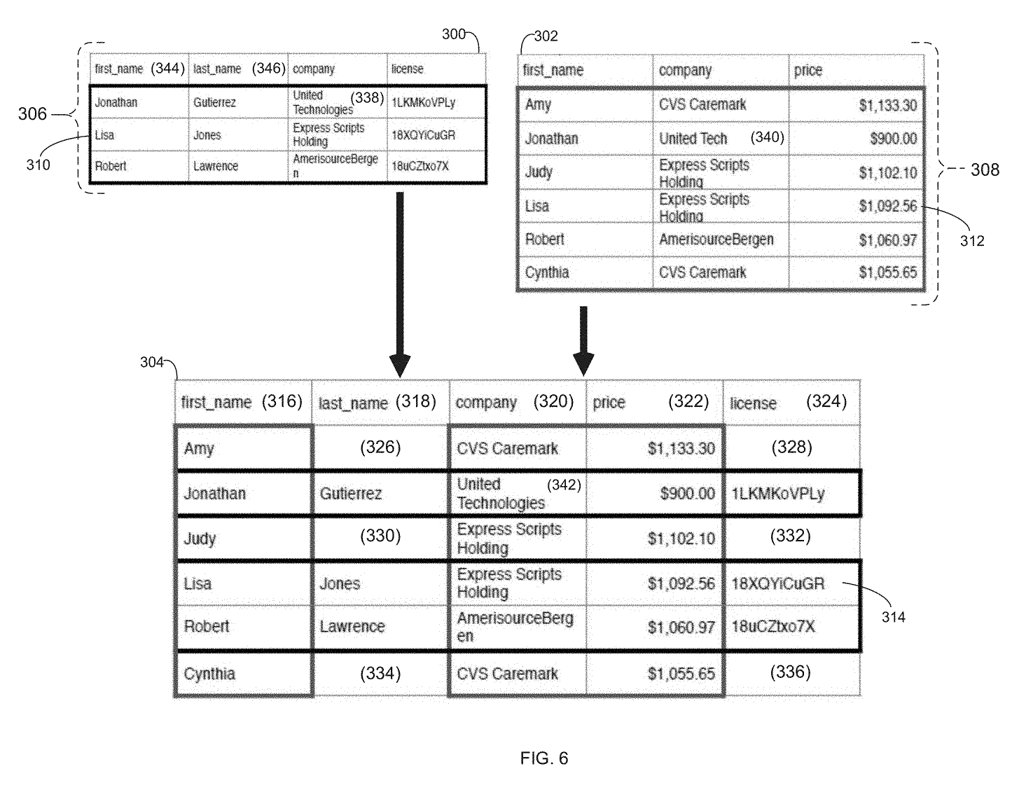

Referring also to FIG. 6, assume for this example that content 56 includes two pieces of content (e.g., table 300 and table 302), wherein the content of table 300 and the content of table 302 may be combined by machine learning data analysis process 10 to form table 304.

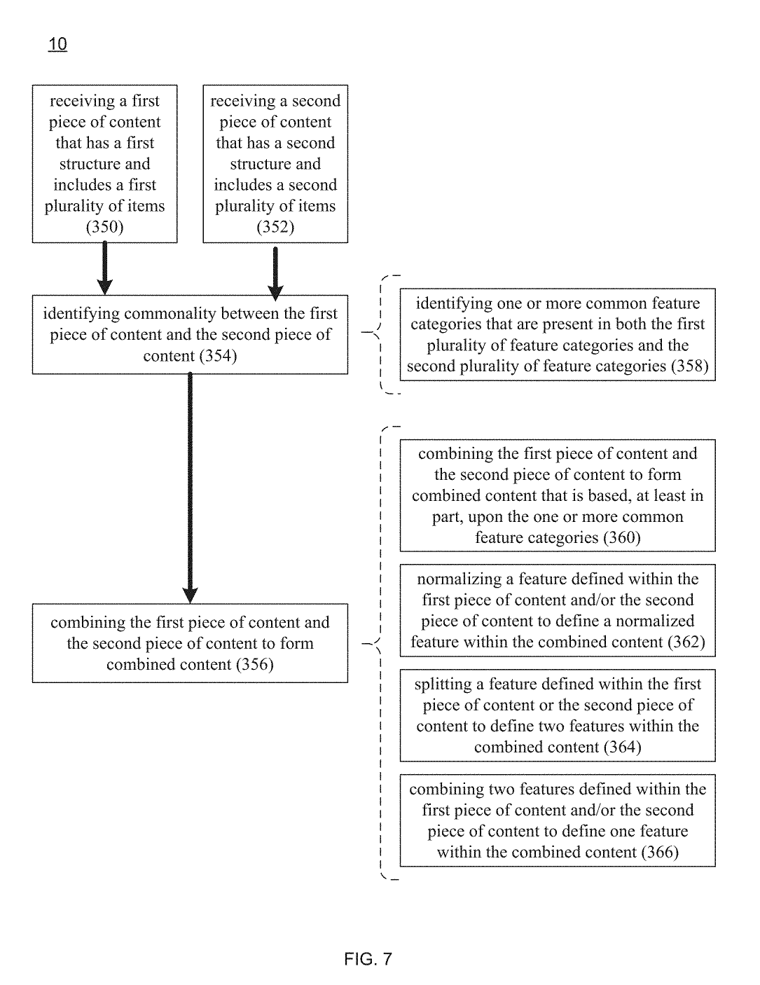

Referring also to FIG. 7, machine learning data analysis process 10 may receive 350 a first piece of content (e.g., table 300) that has a first structure and includes a first plurality of items (e.g., plurality of items 306). Accordingly and in this example, the structure of table 300 (i.e., the first structure) may include a first plurality of feature categories (e.g., “first_name”, “last_name”, “company” and “license”).

Machine learning data analysis process 10 may also receive 352 a second piece of content (e.g., table 302) that has a second structure and includes a second plurality of items (e.g., plurality of items 308). Accordingly and in this example, the structure of table 302 (i.e., the second structure) may include a second plurality of feature categories (e.g., “first_name”, “company”, and “price”).

Machine learning data analysis process 10 may identify 354 commonality between the first piece of content (e.g., table 300) and the second piece of content (e.g., table 302) and may combine 356 the first piece of content (e.g., table 300) and the second piece of content (e.g., table 302) to form combined content (e.g., table 304) that is based, at least in part, upon the identified commonality.

When identifying 354 commonality between the first piece of content (e.g., table 300) and the second piece of content (e.g., table 302), machine learning data analysis process 10 may identify 358 one or more common feature categories that are present in both the first plurality of feature categories (e.g., “first_name”, “last_name”, “company” and “license”) of the first piece of content (e.g., table 300) and the second plurality of feature categories (e.g., “first_name”, “company”, and “price”) of the second piece of content (e.g., table 302).

Since the first piece of content (e.g., table 300) and the second piece of content (e.g., table 302) both include the feature categories “first_name” and “company”, machine learning data analysis process 10 may identify 358 feature categories “first_name” and “company” as common feature categories that are present in both the first plurality of feature categories of the first piece of content (e.g., table 300) and the second plurality of feature categories of the second piece of content (e.g., table 302).

As discussed above, once machine learning data analysis process 10 identifies 354 commonality between the first piece of content (e.g., table 300) and the second piece of content (e.g., table 302), machine learning data analysis process 10 may combine 356 the first piece of content (e.g., table 300) and the second piece of content (e.g., table 302) to form combined content (e.g., table 304) that is based, at least in part, upon the identified commonality, which may include combining 360 table 300 and table 302 to form table 304 that is based, at least in part, upon the one or more common feature categories (e.g., feature categories “first_name” and “company”) that were identified above.

Accordingly, machine learning data analysis process 10 may combine 360 table 300 and table 302 to form table 304 that includes five feature categories (namely “first_name”, “last_name”, “company”, “price” and “license”). For example, machine learning data analysis process 10 may combine 360 item 310 within table 300 (that contains features “Lisa”, “Jones”, “Express Scripts Holding” and “18XQYiCuGR”) and item 312 within table 302 (that contains features “Lisa”, “Express Scripts Holding” and “$1,092.56”) to form item 314 within table 304 (that contains features “Lisa”, “Jones”. “Express Scripts Holding”, “$1,092.56” and “18XQYiCuGR”).

Accordingly and in this example, table 304 is shown to include “first_name” feature category 316, “last_name” feature category 318, “company” feature category 320, “price” feature category 322 and “license” feature category 324, wherein:
machine learning data analysis process 10 may obtain the information included within “first_name” feature category 316 from either table 300 or table 302 (as this is one of the commonalities between table 300 and table 302);
machine learning data analysis process 10 may obtain the information included within “company” feature category 320 from either table 300 or table 302 (as this is one of the commonalities between table 300 and table 302);
machine learning data analysis process 10 may obtain the information included within “last_name” feature category 318 from only table 300 (as table 302 does not include this information);
machine learning data analysis process 10 may obtain the information included within “price” feature category 322 from only table 302 (as table 300 does not include this information); and
machine learning data analysis process 10 may obtain the information included within “license” feature category 324 from only table 300 (as table 302 does not include this information).

As would be expected, table 304 will not include data (e.g., features) that were not included in either of tables 300, 302 or were undeterminable by machine learning data analysis process 10. For example:
cell 326 within table 304 is unpopulated because the last name of “Amy” is not defined within table 300 or table 302 and is undeterminable by machine learning data analysis process 10;
cell 328 within table 304 is unpopulated because the license of “Amy” is not defined within table 300 or table 302 and is undeterminable by machine learning data analysis process 10;
cell 330 within table 304 is unpopulated because the last name of “Judy” is not defined within table 300 or table 302 and is undeterminable by machine learning data analysis process 10;
cell 332 within table 304 is unpopulated because the license of “Judy” is not defined within table 300 or table 302 and is undeterminable by machine learning data analysis process 10;
cell 334 within table 304 is unpopulated because the last name of “Cynthia” is not defined within table 300 or table 302 and is undeterminable by machine learning data analysis process 10; and
cell 336 within table 304 is unpopulated because the license of “Cynthia” is not defined within table 300 or table 302 and is undeterminable by machine learning data analysis process 10.

As will be described below, when combining 356 table 300 and table 302 to form table 304, machine learning data analysis process 10 may normalize 362 content, split 364 content and/or combine 366 content. When performing such normalizing operations, splitting operations, and combining operations, machine learning data analysis process 10 may use the above-described probabilistic modeling to accomplish such operations, wherein examples of such probabilistic modeling may include but are not limited to discriminative modeling, generative modeling, or combinations thereof.

When combining 356 the first piece of content (e.g., table 300) and the second piece of content (e.g., table 302) to form combined content (e.g., table 304) that is based, at least in part, upon the identified commonality (e.g., feature categories “first_name” and “company”), machine learning data analysis process 10 may normalize 362 a feature defined within the first piece of content (e.g., table 300) and/or the second piece of content (e.g., table 302) to define a normalized feature within the combined content (e.g., table 304).

For example and with respect to “Jonathan”, cell 338 within table 300 is shown to include the feature “United Technologies” while cell 340 within table 302 is shown to include the feature “United Tech”. Accordingly, machine learning data analysis process 10 may normalize 362 the feature “United Technologies” within cell 338 of table 300 with the feature “United Tech” within cell 340 of table 302 to define a normalized feature (e.g., United Technologies”) within cell 342 of table 304.

When combining 356 the first piece of content (e.g., table 300) and the second piece of content (e.g., table 302) to form combined content (e.g., table 304) that is based, at least in part, upon the identified commonality (e.g., feature categories “first_name” and “company”), machine learning data analysis process 10 may split 364 a feature defined within the first piece of content (e.g., table 300) or the second piece of content (e.g., table 302) to define two features within the combined content (e.g., table 304).

For example, if one feature category within either table 300 or table 302 is a “name” category that defines the first name and the last name of an employee, machine learning data analysis process 10 may split 364 this single piece of information (e.g., first and last name) into two separate pieces of information that may be placed into two separate categories (e.g., “first_name” category 316 and “last_name” category 318) within table 304.

When combining 356 the first piece of content (e.g., table 300) and the second piece of content (e.g., table 302) to form combined content (e.g., table 304) that is based, at least in part, upon the identified commonality (e.g., feature categories “first_name” and “company”), machine learning data analysis process 10 may combine 366 two features defined within the first piece of content (e.g., table 300) and/or the second piece of content (e.g., table 302) to define one feature within the combined content (e.g., table 304).

For example, if one feature category within table 300 is “first_name” category 344 that defines the first name of an employee and another feature category within table 300 is “last_name” category 346 that defines the last name of an employee, machine learning data analysis process 10 may combine 366 these two pieces of information (e.g., first name and last name) into one single piece of information that may be placed into one category (e.g., a “name” category) within table 304.

User Teachable AI Digital Assistant

As discussed above, when processing the above-described content (e.g., content 56), machine learning data analysis process 10 may use probabilistic modeling to accomplish such processing, wherein examples of such probabilistic modeling may include but are not limited to discriminative modeling (e.g., a probabilistic model for only the content of interest), generative modeling (e.g., a full probabilistic model of all content), or combinations thereof. As discussed above, probabilistic modeling may be used within modern artificial intelligence systems (e.g., machine learning data analysis process 10) and may provide artificial intelligence systems with the tools required to autonomously analyze vast quantities of data.

In order for machine learning data analysis process 10 accurately process the content (e.g., content 56), the above-described probabilistic models must be initially accurate and must be subsequently updated to maintain their accuracy. Accordingly, the following discussion concerns the manner in which such probabilistic models may be initially generated and subsequently maintained and/or updated.

While the following discussion concerns text-based feature groups, this is for illustrative purposes only and is not intended to be a limitation of this disclosure, as other configurations are possible. For example, the feature groups may include but are not limited to e.g., visual feature groups (e.g., images or objects), audio-based feature groups (e.g., sounds or audio clips) and video-based feature groups (e.g., animations or video clips).

Assume for the following discussion that the probabilistic models being developed are going to be used by machine learning data analysis process 10 to classify alcoholic beverages. For example, a group of BRAND options may include Budweiser, Heineken, and Coors; a group of BEVERAGE TYPE options may include light, regular, and non-alcoholic; a group of CONTAINER options may include glass bottle, aluminum bottle, can and barrel; a group of VOLUME options may include 8, 12, 16, 32, 7.75, 15.50 and 31.00; and a group of UNIT options may include ounces and gallons.

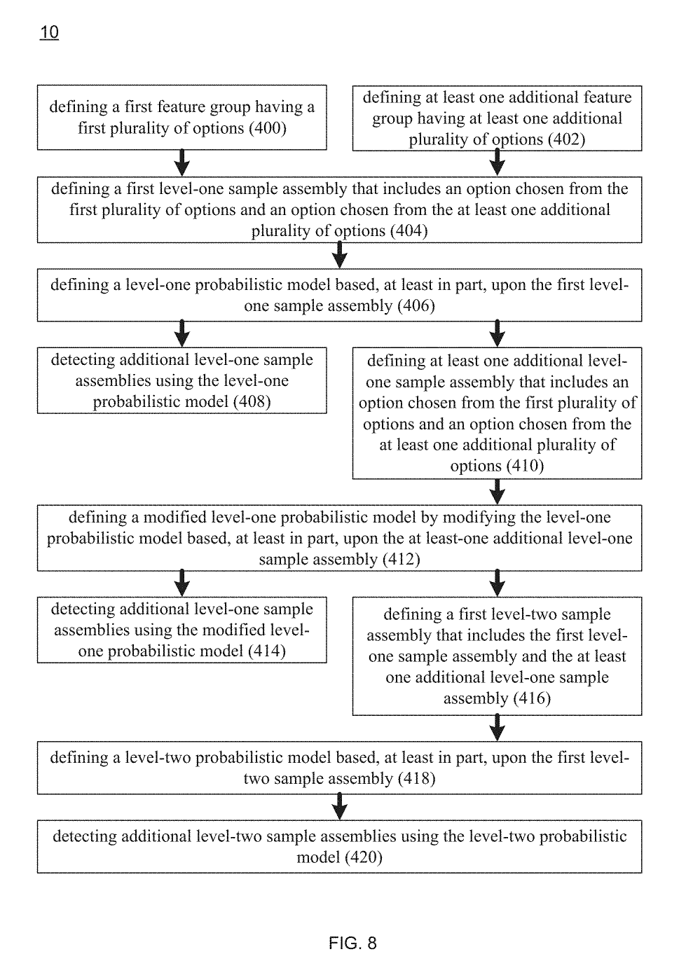

Accordingly and referring also to FIG. 8, when defining a probabilistic model (or probabilistic models) for identifying e.g., the above-described alcohol beverages, a user (e.g., user 36, 38, 40, 42) of machine learning data analysis process 10 may define 400 a first feature group (e.g., a BRAND group) having a first plurality of options (e.g., Budweiser, Heineken, and Coors) and may define 402 at least one additional feature group having at least one additional plurality of options. The process of defining (as used in the following example) may include but is not limited to: the definition being made solely by machine learning data analysis process 10 (e.g., machine learning data analysis process 10 defining autonomously without the involvement of the user); the definition being made solely by a user of machine learning data analysis process 10 (e.g., the user defining autonomously without the involvement of machine learning data analysis process 10); or the definition being made collaboratively by machine learning data analysis process 10 and the user of machine learning data analysis process 10 (e.g., machine learning data analysis process 10 making definition suggestions that require user approval).

Examples of these additional features groups having these additional plurality of options may include but are not limited to:
a second feature group (e.g., a BEVERAGE TYPE group) having a second plurality of options (e.g., light, regular, and non-alcoholic);
a third feature group (e.g., a CONTAINER group) having a third plurality of options (e.g., glass bottle, aluminum bottle, can and barrel);
a fourth feature group (e.g., a VOLUME group) having a fourth plurality of options (e.g., 8, 12, 16, 32, 7.75, 15.50 and 31.00); and
a fifth feature group (e.g., a UNIT group) having a fifth plurality of options (e.g., ounces and gallons).

The above-described information may be provided to machine learning data analysis process 10 in a comma delimited/semicolon delimited format, where commas are used to separate options within a group and semicolons are used to separate the groups. For example, the above-described information may be provided to machine learning data analysis process 10 in the following format: (Budweiser, Heineken, Coors; light, regular, non-alcoholic; glass bottle, aluminum bottle, can, barrel; 8, 12, 16, 32, 7.75, 15.50, 31.00; ounces, gallons).

Machine learning data analysis process 10 may define 404 a first level-one sample assembly that includes an option chosen from the first plurality of options and an option chosen from the at least one additional plurality of options. For example and in the interest of generating probabilistic models for identifying e.g., the above-described alcohol beverages, a user (e.g., user 36, 38, 40, 42) of machine learning data analysis process 10 may define 404 a first level-one sample assembly (e.g., first level-one sample assembly 60) that is an example of a specific beverage. Accordingly, a user of machine learning data analysis process 10 may choose an option from one or more of the BRAND group, the BEVERAGE TYPE group, the CONTAINER group, the VOLUME group; and the UNIT group; wherein an example of level-one sample assembly 60 may be as follows (Budweiser, light, glass bottle, 12, ounce)

Once machine learning data analysis process 10 defines 404 level-one sample assembly 60, machine learning data analysis process 10 may define 406 a level-one probabilistic model (e.g., level-one probabilistic model 62) based, at least in part, upon first level-one sample assembly 60. Since first level-one sample assembly 60 defines an exemplary alcoholic beverage for machine learning data analysis process 10, machine learning data analysis process 10 may utilize first level-one sample assembly 60 as a guide for determining other permutations of alcoholic beverages.

This “learning” process experienced by machine learning data analysis process 10 may not be dissimilar to the manner in which human beings learn. For example, when a parent points to a robin and explains that it is a bird, the child is seeing what is essentially a “level-one sample assembly”. Specifically and from this “level-one sample assembly”, the child may derive what is essentially a “level-one probabilistic model” that defines a bird as a creature that includes red & black feathers, a body, a tail and a pair of wings. Accordingly, the child may then use this “level-one probabilistic model” to determine other permutations of (in this example) birds. Therefore, in the event that the child subsequently sees a blue jay that has blue & white feathers, a body, a tail and a pair of wings, the child may apply the “level-one probabilistic model” and define the blue jay as another type of bird.

Accordingly, machine learning data analysis process 10 may detect 408 additional level-one sample assemblies using level-one probabilistic model 62. Examples of such additional level-one sample assemblies may include but are not limited to: (Budweiser, regular, aluminum bottle, 12, ounce) and (Coors, light, keg, 31, gallon).

In the event that additional training is needed for level-one probabilistic model 62 to e.g., increase its accuracy, a user of machine learning data analysis process 10 may define 410 at least one additional level-one sample assembly by choosing an option from one or more of the BRAND group, the BEVERAGE TYPE group, the CONTAINER group, the VOLUME group; and the UNIT group; wherein an example of additional level-one sample assembly 64 may be as follows (Coors, regular, can, 12, ounce).

Machine learning data analysis process 10 may then define 412 a modified level-one probabilistic model (e.g., modified level-one probabilistic model 62′) by modifying level-one probabilistic model 62 based, at least in part, upon the at least-one additional level-one sample assembly (e.g., additional level-one sample assembly 64). Specifically and when machine learning data analysis process 10 defines 412 modified level-one probabilistic model 62′, modified level-one probabilistic model 62′ may be based upon additional level-one sample assembly 64 and first level-one sample assembly 60. As modified level-one probabilistic model 62′ is based upon two exemplary assemblies (as opposed to one), modified level-one probabilistic model 62′ may provide a higher level of accuracy when machine learning data analysis process 10 uses modified level-one probabilistic model 62′ to detect 414 additional level-one sample assemblies.

While the above-discussion concerned only first level options (e.g., BRAND options Budweiser, Heineken, and Coors; BEVERAGE TYPE options light, regular, and non-alcoholic; CONTAINER options glass bottle, aluminum bottle, can and barrel; VOLUME options 8, 12, 16, 32, 7.75, 15.50 and 31.00; and UNIT options ounces and gallons); this is for illustrative purposes only and is not intended to be a limitation of this disclosure, as other configurations are possible. For example, machine learning data analysis process 10 may define 416 a first level-two sample assembly (e.g., first level-two sample assembly 66) that includes a first level-one sample assembly (e.g., first level-one sample assembly 60) and at least one additional level-one sample assembly (e.g., additional level-one sample assembly 64). Accordingly, if first level-one sample assembly 60 included two options (e.g., Budweiser & Can) and additional level-one sample assembly 64 included two options (12 & Ounce), machine learning data analysis process 10 may define 416 first level-two sample assembly 66 as the sum of first level-one sample assembly 60 and additional level-one sample assembly 64 (namely Budweiser, Can, 12, Ounce).

Machine learning data analysis process 10 may then define 418 a level-two probabilistic model (e.g., level-two probabilistic model 68) based, at least in part, upon first level-two sample assembly 66, wherein machine learning data analysis process 10 may use first level-two sample assembly 66 to detect 420 additional level-two sample assemblies. This generation of probabilistic models at differing (and deeper) levels may be continued in order to enhance the accuracy and efficiency of the system. For example, machine learning data analysis process 10 may define a level-three probabilistic model, a level-four probabilistic model or a level-X probabilistic model.

While the above-discussion concerned the plurality of options being text-based options (e.g., BRAND options Budweiser, Heineken, and Coors; BEVERAGE TYPE options light, regular, and non-alcoholic; CONTAINER options glass bottle, aluminum bottle, can and barrel; VOLUME options 8, 12, 16, 32, 7.75, 15.50 and 31.00; and UNIT options ounces and gallons); this is for illustrative purposes only and is not intended to be a limitation of this disclosure, as other configurations are possible and are considered to be within the scope of this disclosure. For example, the plurality of options may be object-based options.

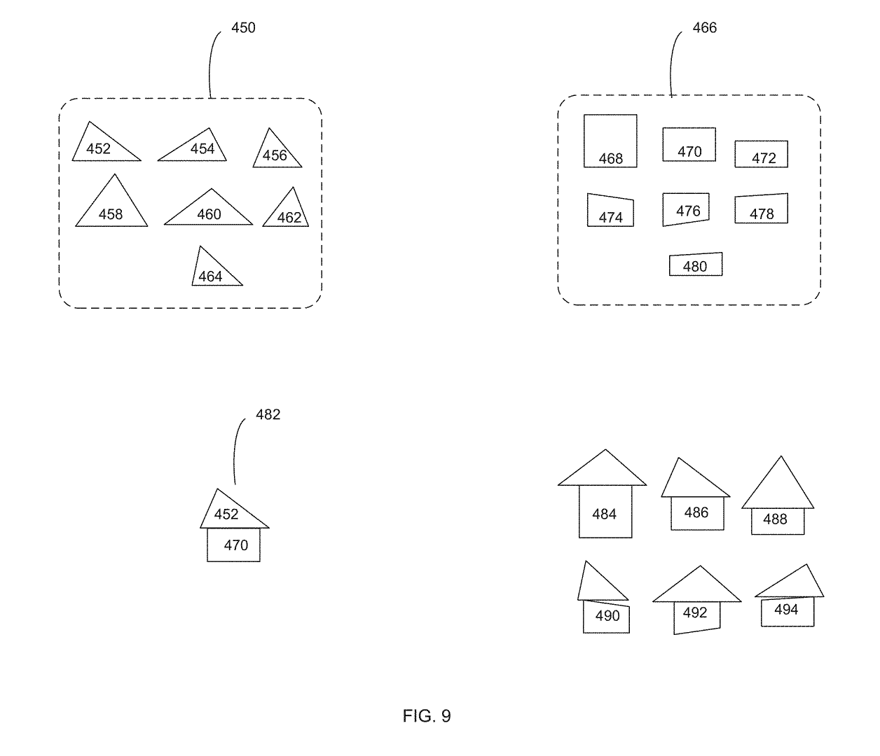

For example and referring also to FIG. 9, assume for the following discussion that the probabilistic models being developed are going to be used by machine learning data analysis process 10 to determine whether or not a user (e.g., user 40) drew e.g., a house on e.g., personal digital assistant 32. For example, machine learning data analysis process 10 may define 400 object-based group 450 of roof objects (e.g., roof object 452, roof object 454, roof object 456, roof object 458, roof object 460, roof object 462, and roof object 464). Further, machine learning data analysis process 10 may define 402 object-based group 466 of structure objects (e.g., structure object 468, structure object 470, structure object 472, structure object 474, structure object 476, structure object 478, and structure object 480).

A user of machine learning data analysis process 10 may define 404 a first level-one sample assembly (e.g., house assembly 482) that includes an option chosen from object-based group 450 of roof objects (e.g., namely roof object 452) and an option chosen from object-based group 466 of structure objects (e.g., namely structure object 470). Machine learning data analysis process 10 may then define 406 a level-one probabilistic model (e.g., level-one probabilistic model 70). Machine learning data analysis process 10 may then detect 408 additional level-one sample assemblies (e.g., house assemblies 484, 486, 488, 490, 492, 494) using level-one probabilistic model 70.

When defining 406, 412, 418 the above-described probabilistic models (e.g., probabilistic models 62, 62′, 68, 70, respectively), examples of such probabilistic models may include but are not limited to discriminative modeling, generative modeling, or combinations thereof (as discussed above).

Further expanding upon the above discussion and in some configurations/embodiments, feature group content may include but is not limited to natural language content (e.g., words) and object content (e.g., drawings, images, or video). Level-one sample assemblies may consist of e.g., collections of words and/or collections of drawings, images, or video.

Natural language feature groups may include lists of words, wherein these lists of words may include words with word co-occurrence statistics that resemble one another. These lists of words may include words with word embedding vectors close to one another. Level-one sample assemblies for natural language may include lists of lists of words, or groups of lists of words. Feature categories for natural language may be recursively defined so that there can be lists of lists of lists or groups of groups of features, etc.

Drawing feature groups may include lines, or collections of lines that are spatially related to one another. The spatial relations may be probabilistic, where e.g., the x, y position of one end of one line may be drawn from a two-dimensional Gaussian distribution with a mean at some x, y coordinates, and one end of another line may also be drawn from a two-dimensional Gaussian distribution with a mean at some x, y coordinates with some offset in relation to the mean of the first Gaussian distribution. Sample assemblies for drawings may include groups of features groups. Sample assemblies for drawings may be recursively defined so that there can be groups of groups of features, etc.

Image feature groups images may include a collection of pixels that are spatially related to one another. The spatial relations may be probabilistic, where e.g., the x, y position of one pixel may be drawn from a two-dimensional Gaussian distribution with a mean at some x, y coordinates, and the x, y coordinates of another pixel may be drawn from another two-dimensional Gaussian distribution with a mean at other x, y coordinates with some offset in relation to the mean of the first Gaussian distribution. Without loss of generality: a feature may be a rectangular patch of N by M pixels where N is length and M is the width of the rectangle; a rectangular patch of pixels may have one or more variables defining one or more angles of rotation; and/or a rectangular patch of pixels may have one or more variables defining one or more stretch or skew.

Image feature groups may include groups of features. For example, image feature groups may include representing a patch of P pixels as a P-dimensional vector of pixel properties (e.g., intensity, color, hue, etc.). Sample assemblies for images may be recursively defined so that there can be groups of groups of features, etc.

Video feature groups may include a collection of pixels that are spatially and temporally related to one another. The spatial relations may be somewhat probabilistic, where e.g., the x, y, t (time) position of one pixel or set of pixels may be drawn from a probabilistic program, and the x, y, t coordinates of another pixel or set of pixels may be drawn from another probabilistic program. Without loss of generality: a feature may be a rectangular patch of N by M pixels where N is length of the rectangle and M is the width of the rectangle; a rectangular patch of pixels may have one or more variables defining one or more angles of rotation; and/or a rectangular patch of pixels may have one or more variables defining one or more stretch or skew.

Video feature categories may include groups of feature groups. For example video feature groups may include representing a patch of P pixels as a P-dimensional vector of pixel properties (e.g., intensity, color, hue, etc.). Sample assemblies for videos may be recursively defined so that there can be groups of groups of feature groups, etc.

Surplus Content Detection System

As discussed above, when processing the above-described content (e.g., content 56), machine learning data analysis process 10 may use probabilistic modeling to accomplish such processing, wherein examples of such probabilistic modeling may include but are not limited to discriminative modeling (e.g., a probabilistic model for only the content of interest), generative modeling (e.g., a full probabilistic model of all content), or combinations thereof. As discussed above, probabilistic modeling may be used within modern artificial intelligence systems (e.g., machine learning data analysis process 10) and may provide artificial intelligence systems with the tools required to autonomously analyze vast quantities of data.

For example, machine learning data analysis process 10 may define an initial probabilistic model for accomplishing a defined task. For example, assume that this defined task is analyzing customer feedback that is received from customers of e.g., a ride-hailing company via an automated feedback phone line.

Accordingly, machine learning data analysis process 10 may define a plurality of root words and their synonyms for use with machine learning data analysis process 10. For example, machine learning data analysis process 10 may define the word “car” and synonyms for “car” (such as: “ride”, “vehicle”, “auto”, “automobile” and “cab”). Machine learning data analysis process 10 may also define the word “driver” and synonyms for “driver” (such as: “cabbie” and “chauffer”). Machine learning data analysis process 10 may further define the word “good” and synonyms for “good” (such as: “professional”, “wonderful”, “lovely”, “great”, “perfect”, “amazing”, “pleasant” and “happy”). Further, machine learning data analysis process 10 may define the word “bad” and synonyms for “bad” (such as: “unprofessional”, “awful”, “horrible”, “terrible”, “hideous”, “scary”, “frightening” and “miserable”). Additionally, machine learning data analysis process 10 may define the word “the” and synonyms for “the” (such as: “my” and “this”).

The above-described information may be provided to machine learning data analysis process 10 in a comma delimited/semicolon delimited format, where commas are used to separate options within a group and semicolons are used to separate the groups. For example, the above-described information may be provided to machine learning data analysis process 10 in the following format: (car, ride, vehicle, auto, automobile, cab; driver, cabbie, chauffer; good, professional, wonderful, lovely, great, perfect, amazing, pleasant, happy; bad, unprofessional, awful, horrible, terrible, hideous, scary, frightening, miserable; the, my, this).

While the words defined above (and their synonyms) may all be considered level-one words (single words), this is for illustrative purposes only and is not intended to be a limitation of this disclosure, as other configurations are possible. For example, machine learning data analysis process 10 may define level-two combinations that include a plurality of level-one words, wherein only a single word may be chosen from each group of words. For example, a user (e.g., user 36, 38, 40, 42) of machine learning data analysis process 10 may define the following level-two combinations: my + driver, the + driver, was + nice, was + professional, was + rude and was + unprofessional.

Continuing with the above-stated example, assume for illustrative purposes that a user (e.g., user 36, 38, 40, 42) of the above-stated machine learning data analysis process 10 provides feedback to the raid-hailing company in the form of speech provided to an automated feedback phone line. Assume for this example that user 36 uses data-enabled, cellular telephone 28 to provide feedback 72 to the automated feedback phone line.

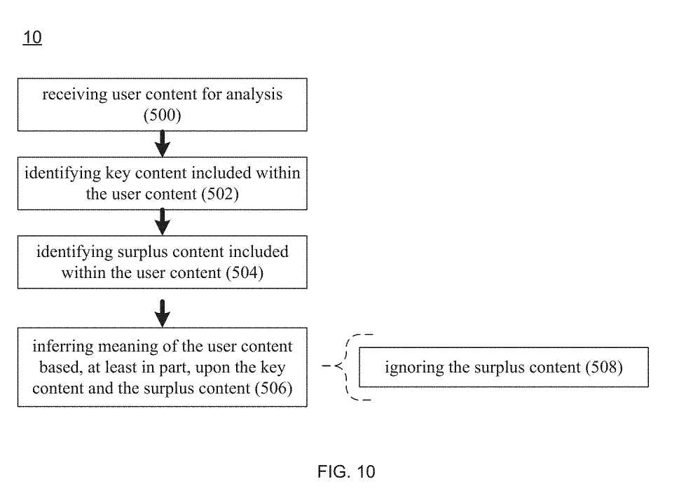

Accordingly and referring also to FIG. 10, machine learning data analysis process 10 may receive 500 user content (e.g., feedback 72) for analysis. When analyzing feedback 72, machine learning data analysis process 10 may identify 502 key content included within the user content (e.g., feedback 72) and may identify 504 surplus content included within the user content (e.g., feedback 72). For this example, key content may be content (e.g., words or combinations of words) that are defined by machine learning data analysis process 10 in the manner described above, examples of which may include but are not limited to: one or more single words; one or more compound words (each of which includes two or more single words); one or more lists of single words; one or more lists of compound words; and one or more groups of lists.

Continuing with the above example, assume that user 36 was not happy with their experience with the ride-hailing company and that feedback 72 that was provided by user 36 was “my driver was not professional”. Upon receiving 500 the user content (e.g., feedback 72) for analysis, this user content (e.g., feedback 72) may be preprocessed (via e.g., a machine process or a third-party) prior to machine learning data analysis process 10 identifying 502 the key content included within this user content (e.g., feedback 72). Examples of such preprocessing may include but are not limited to: the correction of spelling errors (e.g., correcting my driver was not “professnal”), the inclusion of synonyms (e.g., my=our), and the removal of irrelevant comments (e.g., removing “and the weather was rainy”). Accordingly and for this example, such user content (e.g., feedback 72) may be the unprocessed feedback or may be the preprocessed feedback, wherein the author of this feedback may be the user, the third-party, or a collaboration of both. Continuing with the above-stated example, machine learning data analysis process 10 may identify 502 the key content (included within feedback 72) as four level-one words (e.g., “my”, “driver”, “was”, “professional”) and/or two level-two combinations (e.g., my + driver, was + professional). Accordingly and if machine learning data analysis process 10 simply relied upon key word identification, feedback 72 may be interpreted as positive feedback (even though feedback 72 was clearly negative feedback).

Accordingly, machine learning data analysis process 10 may also identify 504 surplus content within feedback 72. Accordingly, machine learning data analysis process 10 may identify 504 surplus content (included within feedback 72) as one word, namely “not”.

Machine learning data analysis process 10 may then infer 506 the meaning of the user content (e.g., feedback 72) based, at least in part, upon the key content (e.g., “my”, “driver”, “was”, “professional” and/or my + driver, was + professional) and the surplus content (e.g., “not”).

As is known in the art, the word “not” is an adverb that may be used to form the negative of model verbs. Accordingly and when positioned in front of another word, the net result is the word following “not” having the opposite of its normal meaning. So while a driver being “professional” is a positive attribute; a driver being “not professional” is a negative attribute. Accordingly and continuing with the above-stated example, since “not” is positioned directly in front of “professional”, machine learning data analysis process 10 may infer that the meaning of not + professional is “not professional”.

Accordingly, machine learning data analysis process 10 may infer 506 that feedback 72 is negative feedback and may route feedback 72 to the appropriate customer service representative (or voice mailbox) within ride-hailing company (or their designated agent).

It is foreseeable that some surplus content may have little (if any) impact when machine learning data analysis process 10 infers 506 the meaning of feedback 72. For example, assume that feedback 72 that was provided by user 36 was “my driver was quite professional”. Since “quite” is an adverb that provides a middle-of-the-road level of magnitude to the verb in question (as opposed to “very” or “barely”), the surplus content (e.g., “quite”) within feedback 72 may not really alter the manner in which machine learning data analysis process 10 infers 506 the meaning of feedback 72. Accordingly and when inferring 506 the meaning of the user content (e.g., feedback 72) based, at least in part, upon the key content (e.g., “my”, “driver”, “was”, “professional”) and the surplus content (e.g., “quite”), machine learning data analysis process 10 may ignore 508 the surplus content (e.g., “quite”).

While in the above-described example, the user content (e.g., feedback 72) was described as text-based user content that includes one or more of: one or more single words; and one or more compound words (each of which may include two or more single words), this is for illustrative purposes only and is not intended to be a limitation of this disclosure, as other configurations are possible.

For example, the user content (e.g., feedback 72) may be object-based user content that may include one or more of: one or more single objects; one or more compound objects (each of which may include two or more single objects); one or more lists of single objects; one or more lists of compound objects; and one or more groups of lists.

For example, instead of defining a plurality of words (and their synonyms) for use by machine learning data analysis process 10, machine learning data analysis process 10 may define a plurality of objects (and their similar) for use by machine learning data analysis process 10. Examples of such plurality of objects (and their similar) may include object-based group 450 of roof objects (see FIG. 9) and object-based group 466 of structure objects (see FIG. 9).

Further expanding upon the above discussion and in some configurations/embodiments, ignoring 508 the surplus content may include “explaining away” the surplus content by inferring which surplus features (or which surplus feature categories) are present in the user content, and further which part of the user content may be explained by the surplus features (or surplus feature categories) so that the surplus content no longer needs to be considered by machine learning data analysis process 10 for inferring meaning.

Inferring 506 may be accomplished through any inference or learning algorithm for optimizing or estimating the values or distribution over values of parameters or variables in a model. A model may be a probabilistic program or other probabilistic model. The variables or parameters may control the quantity, composition, and/or grouping of features and feature categories. The inference or learning algorithm could include Markov Chain Monte Carlo (MCMC). The Markov Chain Monte Carlo (MCMC) may be Metropolis-Hastings MCMC (MH-MCMC). The MH-MCMC may utilize custom proposals to e.g., add, remove, delete, augment, merge, split, or compose features (or categories of features). The inference or learning algorithm may alternatively (or additionally) include Belief Propagation or Mean-Field algorithms. The inference or learning algorithm may alternatively (or additionally) include gradient descent based methods. The gradient descent based methods may alternatively (or additionally) include auto-differentiation, back-propagation, and/or black-box variational methods.

Inference Pausing System

As discussed above, when processing the above-described content (e.g., content 56), machine learning data analysis process 10 may use probabilistic modeling to accomplish such processing, wherein examples of such probabilistic modeling may include but are not limited to discriminative modeling (e.g., a probabilistic model for only the content of interest), generative modeling (e.g., a full probabilistic model of all content), or combinations thereof. As discussed above, probabilistic modeling may be used within modern artificial intelligence systems (e.g., machine learning data analysis process 10) and may provide artificial intelligence systems with the tools required to autonomously analyze vast quantities of data.

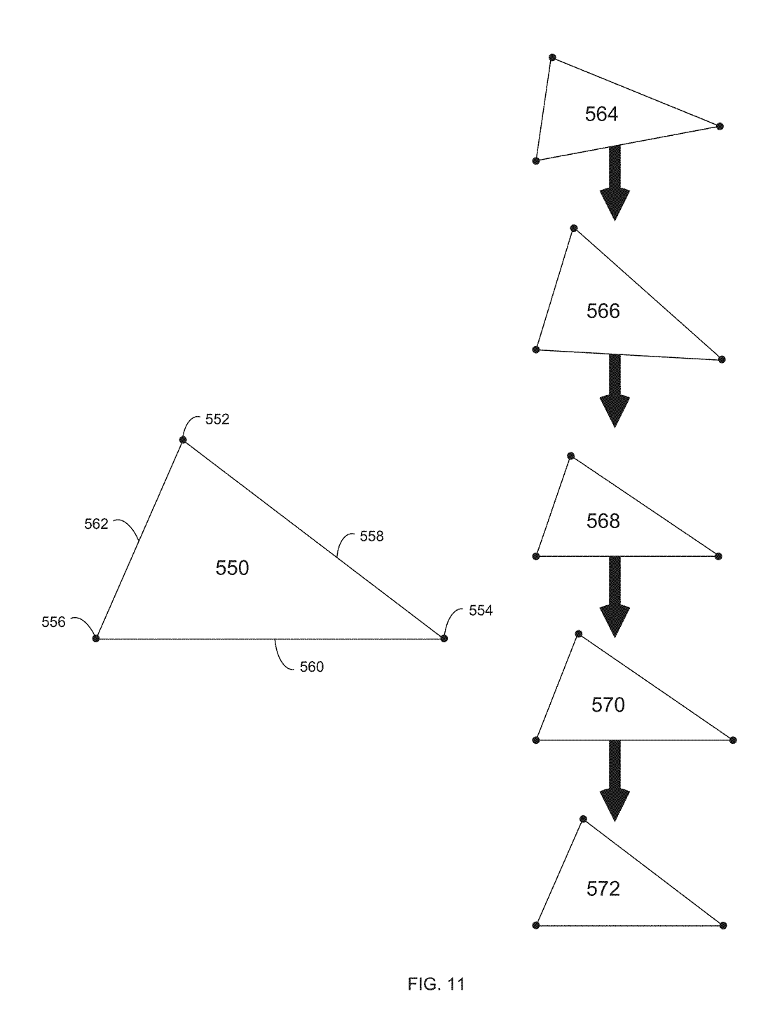

Referring also to FIG. 11, machine learning data analysis process 10 may define a probabilistic model (e.g., probabilistic model 74) for accomplishing a defined task. For example, assume that the defined task that probabilistic model 74 needs to accomplish is the copying of an image (e.g., triangle 550), wherein triangle 550 includes three data points (e.g., data points 552, 554, 556) having a line segment positioned between each set of data points. For example, line segment 558 may be positioned between data points 552, 554; line segment 560 may be positioned between data points 554, 556; and line segment 562 may be positioned between data points 556, 552.

As is known in the art, probabilistic models (such as probabilistic model 74) may include one or more variables that are utilized during the modeling (i.e., inferencing) process. Accordingly and for this simplified example, probabilistic model 74 may include three variables that define the location of each of data points 552, 554, 556, wherein the three variables may be repeatedly changed/adjusted during inferencing, resulting in the generation of many triangles. Each of these generated triangles may be compared to the desired triangle (e.g., triangle 550) to determine if the generated triangle is sufficiently similar to the desired triangle (e.g., triangle 550). Once a triangle is generated that is sufficiently similar to (in this example) triangle 550, the inferencing process may stop and the desired task may be considered accomplished.

According and when probabilistic model 74 is utilized to model triangle 550, the following abbreviated sequence of steps may occur:
machine learning data analysis process 10 may define an initial set of locations for data points 552, 554, 556 and line segments may be drawn between these data points, resulting in the generation of triangle 564;
machine learning data analysis process 10 may then compare triangle 564 to triangle 550 to determine whether triangle 564 is sufficiently similar to triangle 550 (this may be accomplished by assigning a matching score to triangle 564);
assuming triangle 564 is not sufficiently similar to triangle 550, machine learning data analysis process 10 may define a new set of locations for data points 552, 554, 556 and line segments may be drawn between these data points, resulting in the generation of triangle 566;
machine learning data analysis process 10 may then compare triangle 566 to triangle 550 to determine whether triangle 566 is sufficiently similar to triangle 550 (this may be accomplished by assigning a matching score to triangle 566);
assuming triangle 566 is not sufficiently similar to triangle 550, machine learning data analysis process 10 may define a new set of locations for data points 552, 554, 556 and line segments may be drawn between these data points, resulting in the generation of triangle 568;
machine learning data analysis process 10 may then compare triangle 568 to triangle 550 to determine whether triangle 568 is sufficiently similar to triangle 550 (this may be accomplished by assigning a matching score to triangle 568);
assuming triangle 568 is not sufficiently similar to triangle 550, machine learning data analysis process 10 may define a new set of locations for data points 552, 554, 556 and line segments may be drawn between these data points, resulting in the generation of triangle 570;
machine learning data analysis process 10 may then compare triangle 570 to triangle 550 to determine whether triangle 570 is sufficiently similar to triangle 550 (this may be accomplished by assigning a matching score to triangle 570);
assuming triangle 570 is not sufficiently similar to triangle 550, machine learning data analysis process 10 may define a new set of locations for data points 552, 554, 556 and line segments may be drawn between these data points, resulting in the generation of triangle 572; and
machine learning data analysis process 10 may then compare triangle 572 to triangle 550 to determine whether triangle 572 is sufficiently similar to triangle 550 (this may be accomplished by assigning a matching score to triangle 572).

Assume that upon comparing triangle 572 to triangle 550, machine learning data analysis process 10 determines that triangle 572 is sufficiently similar to triangle 550. Accordingly, machine learning data analysis process 10 may consider the task accomplished and the inferencing process may cease.

While the above-described example is explained to include three variables, this is for illustrative purposes only and is not intended to be a limitation of this disclosure, as other configuration are possible. For example, probabilistic models (such as probabilistic model 74) may include thousands of variables. And unfortunately, some of these variables may complicate the analysis process defined above, resulting e.g., unmanageable data sets or unsuccessful conclusions (e.g., the desired task not being accomplished). Accordingly and as will be explained below, machine learning data analysis process 10 may be configured to allow a user to condition one or more variables within a probabilistic model (such as probabilistic model 74).

For example and when conditioning a variable within a probabilistic model (such as probabilistic model 74), machine learning data analysis process 10 may be configured to allow a user (e.g., user 36, 38, 40, 42) to:
define a selected value for a variable;
define an excluded value a variable; and
release control of a variable.

Accordingly, assume that the modeling of triangle 550 is more complex due to numerous factors concerning the makeup of triangle 550 (e.g., the use of varying line thicknesses, the use of smoothing radii at the end points, the use of complex fill patterns within triangle 550, the use of color), resulting in probabilistic equation 74 having thousands of variables. This drastic increase in variables within probabilistic equation 74 may result in the inferencing of probabilistic equation 74 becoming more complex and time consuming. Accordingly, machine learning data analysis process 10 may be configured to allow a user to condition one or more variables within a probabilistic model (such as probabilistic model 74) to better control the inferencing process.

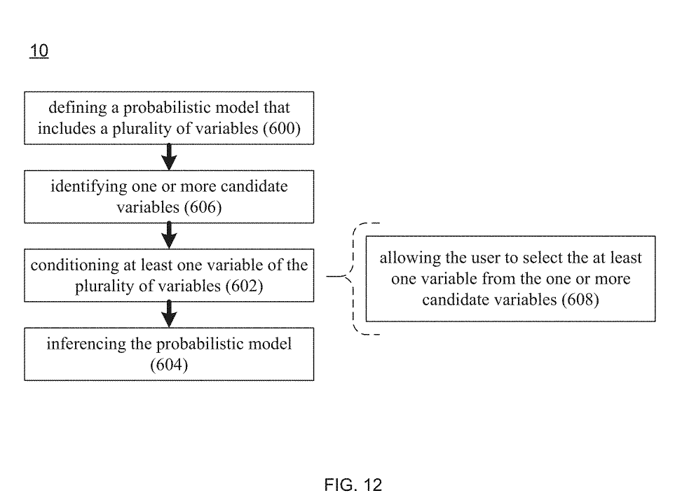

Referring also to FIG. 12 and continuing with the above-stated example, machine learning data analysis process 10 may define 600 a probabilistic model (probabilistic model 74) that includes a plurality of variables (e.g., thousands of variables) and is designed to accomplish a desired task (such as the copying of triangle 550). As discussed above, each of these variables may be repeatedly changed/adjusted during inferencing, resulting in the generation of many triangles, which are compared to the desired triangle (e.g., triangle 550) to determine if a generated triangle is sufficiently similar to the desired triangle (e.g., triangle 550). As also discussed above, once a triangle is generated that is sufficiently similar to (in this example) triangle 550, the inferencing process may stop and the desired task may be considered accomplished.

In order to better control the inferencing process, machine learning data analysis process 10 may condition 602 at least one variable of the plurality of variables based, at least in part, upon a conditioning command (e.g., conditioning command 76) received from a user (e.g., user 36, 38, 40, 42) of machine learning data analysis process 10, thus defining a conditioned variable (e.g., conditioned variable 78).

Conditioning command 76 may be configured to allow a user (e.g., user 36, 38, 40, 42) of machine learning data analysis process 10 to:
define a selected value for a variable;
define an excluded value for a variable; and
release control of a variable.

When defining a selected value for a variable, machine learning data analysis process 10 may allow a user (e.g., user 36, 38, 40, 42) to specify a specific value for a variable (e.g., the location of a data point must be X, the thickness of a line must be Y, the radius of a curve must be Z). This may be accomplished via e.g., a drop down menu or a data entry field rendered by machine learning data analysis process 10.

When defining an excluded value for a variable, machine learning data analysis process 10 may allow a user (e.g., user 36, 38, 40, 42) to exclude a specific value for a variable (e.g., the location of a data point cannot be A, the thickness of a line cannot be B, the radius of a curve cannot be C). This may be accomplished via e.g., a drop down menu or a data entry field rendered by machine learning data analysis process 10.

When releasing control of a variable, machine learning data analysis process 10 may allow a user (e.g., user 36, 38, 40, 42) to remove a limitation previously placed on a variable. For example, if a user (e.g., user 36, 38, 40, 42) previously defined (or excluded) a specific value for a variable, machine learning data analysis process 10 may allow the user to remove that limitation. This may be accomplished via e.g., a drop down menu or a data entry field rendered by machine learning data analysis process 10.

Once conditioned 602, machine learning data analysis process 10 may inference 604 probabilistic model 74 based, at least in part, upon conditioned variable 78 (which may increase the efficiency of the inferencing of probabilistic model 74).

Machine learning data analysis process 10 may be configured to monitor the efficiency and progress of the inferencing of (in this example) probabilistic model 74. For example, assume that there are ten variables within probabilistic model 74 that are loading (e.g., bogging down) the inferencing of probabilistic model 74. Accordingly, machine learning data analysis process 10 may be configured to identify 606 one or more candidate variables (e.g., candidate variables 80), chosen from the plurality of variables, to the user (e.g., user 36, 38, 40, 42) for potential conditioning selection. Accordingly and continuing with the above-stated example, candidate variables 80 identified 606 by machine learning data analysis process 10 may define these ten variables.

Therefore and when conditioning 602 at least one variable of the plurality of variables (included within probabilistic model 74), machine learning data analysis process 10 may allow 608 the user (e.g., user 36, 38, 40, 42) to select the variable to be conditioned from the variables defined within candidate variables 80, which may increase the efficiency of the inferencing of probabilistic model 74 since these variables were identified by machine learning data analysis process 10 as loading (e.g., bogging down) the inferencing of probabilistic model 74.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
defining a first feature group having a first plurality of options;
defining at least one additional feature group having at least one additional plurality of options;
defining a first level-one sample assembly that includes an option chosen from the first plurality of options and an option chosen from the at least one additional plurality of options; and
defining a level-one probabilistic model based, at least in part, upon the first level-one sample assembly.

2. The computer-implemented method of claim 1 further comprising:
detecting additional level-one sample assemblies using the level-one probabilistic model.

3. The computer-implemented method of claim 1 further comprising:
defining at least one additional level-one sample assembly that includes an option chosen from the first plurality of options and an option chosen from the at least one additional plurality of options; and
defining a modified level-one probabilistic model by modifying the level-one probabilistic model based, at least in part, upon the at least-one additional level-one sample assembly.

4. The computer-implemented method of claim 3 further comprising:
detecting additional level-one sample assemblies using the modified level-one probabilistic model.

5. The computer-implemented method of claim 3 further comprising:
defining a first level-two sample assembly that includes the first level-one sample assembly and the at least one additional level-one sample assembly; and
defining a level-two probabilistic model based, at least in part, upon the first level-two sample assembly.

6. The computer-implemented method of claim 5 further comprising:
detecting additional level-two sample assemblies using the level-two probabilistic model.

7. The computer-implemented method of claim 1 wherein the first plurality of options and/or the at least one additional plurality of options define one or more of text-based options and object-based options.

8. A computer program product residing on a computer readable medium having a plurality of instructions stored thereon which, when executed by a processor, cause the processor to perform operations comprising:
defining a first feature group having a first plurality of options;
defining at least one additional feature group having at least one additional plurality of options;
defining a first level-one sample assembly that includes an option chosen from the first plurality of options and an option chosen from the at least one additional plurality of options; and
defining a level-one probabilistic model based, at least in part, upon the first level-one sample assembly.

9. The computer program product of claim 8 further comprising:
detecting additional level-one sample assemblies using the level-one probabilistic model.

10. The computer program product of claim 8 further comprising:
defining at least one additional level-one sample assembly that includes an option chosen from the first plurality of options and an option chosen from the at least one additional plurality of options; and
defining a modified level-one probabilistic model by modifying the level-one probabilistic model based, at least in part, upon the at least-one additional level-one sample assembly.

11. The computer program product of claim 10 further comprising:
detecting additional level-one sample assemblies using the modified level-one probabilistic model.

12. The computer program product of claim 10 further comprising:
defining a first level-two sample assembly that includes the first level-one sample assembly and the at least one additional level-one sample assembly; and
defining a level-two probabilistic model based, at least in part, upon the first level-two sample assembly.

13. The computer program product of claim 12 further comprising:
detecting additional level-two sample assemblies using the level-two probabilistic model.

14. The computer program product of claim 8 wherein the first plurality of options and/or the at least one additional plurality of options define one or more of text-based options and object-based options.

15. A computing system including a processor and memory configured to perform operations comprising:
defining a first feature group having a first plurality of options;
defining at least one additional feature group having at least one additional plurality of options;
defining a first level-one sample assembly that includes an option chosen from the first plurality of options and an option chosen from the at least one additional plurality of options; and
defining a level-one probabilistic model based, at least in part, upon the first level-one sample assembly.

16. The computing system of claim 15 further configured to perform operations comprising:
detecting additional level-one sample assemblies using the level-one probabilistic model.

17. The computing system of claim 15 further configured to perform operations comprising:
defining at least one additional level-one sample assembly that includes an option chosen from the first plurality of options and an option chosen from the at least one additional plurality of options; and
defining a modified level-one probabilistic model by modifying the level-one probabilistic model based, at least in part, upon the at least-one additional level-one sample assembly.

18. The computing system of claim 17 further configured to perform operations comprising:
detecting additional level-one sample assemblies using the modified level-one probabilistic model.

19. The computing system of claim 17 further configured to perform operations comprising:
defining a first level-two sample assembly that includes the first level-one sample assembly and the at least one additional level-one sample assembly; and
defining a level-two probabilistic model based, at least in part, upon the first level-two sample assembly.

20. The computing system of claim 19 further configured to perform operations comprising:
detecting additional level-two sample assemblies using the level-two probabilistic model.

21. The computing system of claim 15 wherein the first plurality of options and/or the at least one additional plurality of options define one or more of text-based options and object-based options.
